(19) United States
(12) Patent Application Publication
(10) Pub. No.: US 2006/0207513 A1
(43) Pub. Date: Sep. 21, 2006

(54) Deer feed spreader

(76) Inventor: Jay Carroll, Houston, TX (US)

Correspondence Address: Steven Thrasher, 391 Sandhill Dr., Richardson, TX, 75080, US

(21) Appl. No.: 11/082,107

(22) Filed: Mar. 16, 2005

(51) Int. Cl. A01K 5/00

(52) U.S. Cl. 119/57.91

(57) ABSTRACT

The invention is a backpack assembly adapted to be carried on the back of a user, and to hold deer feed so that the deer feed may be easily spread by the user. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims.

### TECHNICAL FIELD OF THE INVENTION

The invention relates generally to deer feed, and, more specifically, to deer feed spreaders.

### PROBLEM STATEMENT

Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Problem Statement is to be construed as prior art.

Discussion

Deer feeders are used during hunting season to both build a healthier deer population, and to encourage a population to gather in a desired location. This is sometimes referred to as a game-management system. Deer feeders are typically stationary, often taking the appearance of a small, elevated grain silos or barrels. Although these deer feeders may provide a reliable and continuous supply of deer feed, the supply is very difficult to move. Accordingly, there is little spread in the feed.

In addition, there are a great many kinds of deer feed available that have different proportions of corn, soybeans, rice bran, nuts, pellets, peanut butter, and many other components. If a user employs a stationary feeder, then his ability to experiment with different feeds or to change feeds with the season is severely limited. Furthermore, the transport and disposal of prior art deer feeders is problematic. Accordingly, there is a need for a device that overcomes these shortcomings associated with the distribution of deer feed.

### BRIEF DESCRIPTION OF THE DRAWINGS

Various aspects of the invention, as well as an embodiment, are better understood by reference to the following detailed description. To better understand the invention, the detailed description should be read in conjunction with the drawings in which:

FIG. 1 shows a back panel of a deer feed backpack.

FIG. 2 is a side panel view of a deer feed backpack.

FIG. 3 illustrates a back panel of an alternative embodiment of a deer feed backpack.

FIG. 4 shows a front panel view of the deer feed backpack illustrated in FIG. 3.

### EXEMPLARY EMBODIMENT OF A BEST MODE

Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for—functioning—” or “step for—functioning—” in the Claims section. Sixth, the invention is also described in view of the Festo decisions, and, in that regard, the claims and the invention incorporate equivalents known, unknown, foreseeable, and unforeseeable. Seventh, the language and each word used in the invention should be given the ordinary interpretation of the language and the word, unless indicated otherwise.

Of course, the foregoing discussions and definitions are provided for clarification purposes and are not limiting. Words and phrases are to be given their ordinary plain meaning unless indicated otherwise.

Description of the Drawings

The invention provides advantages as a backpack adapted to function as a deer feeder. By storing and dispensing deer feed from a backpack, a user has significant control over the area being covered with deer feed, and also has control over the type or mixture of deer feed. In addition, the problem of a stationary deer feeder scaring deer is eliminated. Furthermore, transport of the present invention is easy, and there are no disposal issues. Of course, the teachings of the invention are applicable to many other arts, and the invention may be used to spread any feed, seed, fertilizer or other dry material.

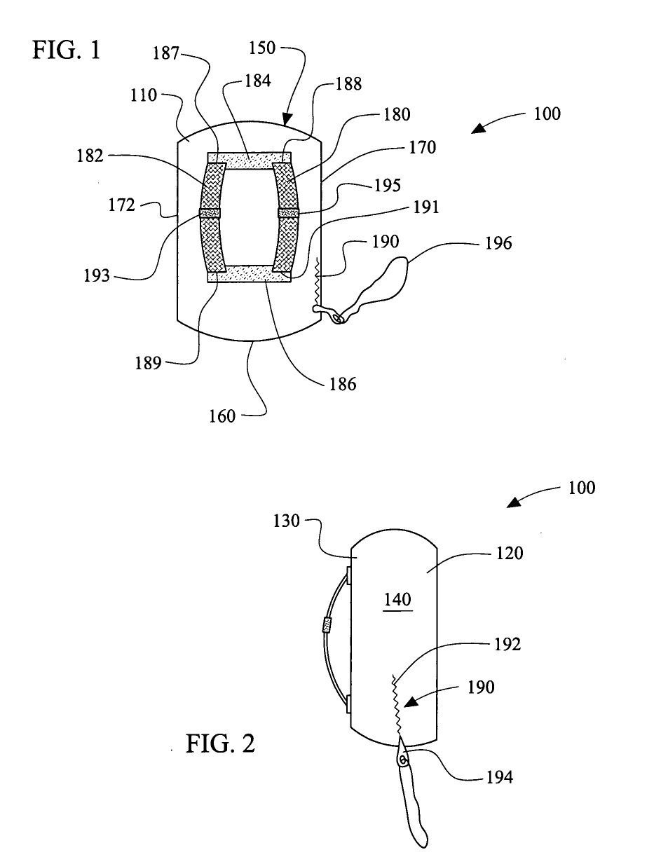

FIG. 1 shows a back panel of a deer feed backpack 100. Reference is also made to FIG. 2, which is discussed below in more detail. Generally, the backpack 100 is an assembly adapted to be carried on the back of a person. The backpack 100 comprises a pack 110 having a front panel 120, a back panel 130, and a chamber 140 defined between the front panel 120 and back panel 130. The chamber 140 has an interior defined by interior portions of panels (not shown, but readily understood by those of skill in the art upon reading the present disclosure). The interior portions include an interior portion of the front panel 120, an interior portion of the back panel 130, an interior portion of a top panel 150, an interior portion of a bottom panel 160, and interior portions of opposing side panels 170, 172. A pair of shoulder straps 180, 182 secured to the pack such that with the straps positioned over the shoulders of a user the front panel is generally parallel to the back of the user. A deer feed dispenser 190 comprising a conduit 192, and a conduit closer is also disposed on the backpack 100.

Since deer feed is commonly available in fifty-pound sacks, the panels of the backpack 100 are preferably strong canvass or other machine-washable material. However, the panels may be made of fiberglass, mesh (that can hold a bag of feed), or other materials. In one embodiment, the panels comprise a camouflaged exterior. In yet another embodiment, the deer feed dispenser 100 is the only means of entry to or exit from the chamber 140. Accordingly, in one embodiment, the deer feed dispenser 190 is a zipper that is no longer than six inches in length.

The backpack 100 also includes a first horizontal reinforcement 184 and a second horizontal reinforcement 186 coupled to the back panel 130. Here, first ends 187, 188 of the shoulder straps 180, 182 are coupled to the fist horizontal reinforcement 184, and second ends 189, 191 of shoulder straps 180, 182 are coupled to the second reinforcement 186. Each of the shoulder straps 180, 182 are length-adjustable via buckles 193, 195 or other means known, foreseeable, or unforeseeable.

FIG. 2 is a side panel view of the deer feed backpack 100. Here, particular attention is given to the dispenser 190, which is here located on the side panel 170. However, it should be understood that the dispenser 190 may be located on any panel from which deer feed may be gravity-fed into the dispenser 190. Accordingly, the dispenser may be located in the bottom panel 160. It is also seen from this view that the dispenser 190 is herein embodied as a zipper having a lanyard 196 attached thereto.

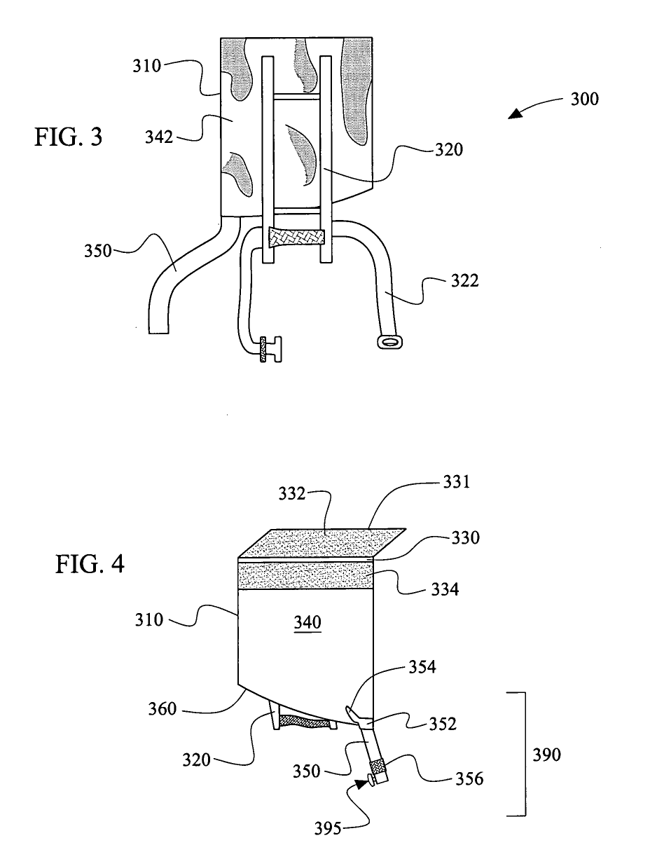

Additional advantages may be realized by incorporating additional features into the invention. For example, FIG. 3 illustrates a back panel of an alternative embodiment of a deer feed backpack 300. To facilitate discussion, like-elements of the backpack 100 and the backpack 300 are not discussed here in detail, except where amplification of an element lends itself to better understanding of the invention. FIG. 4 shows a front panel view of the deer feed backpack 300 illustrated in FIG. 3, and the below discussion is made with reference to both FIG. 3 and FIG. 4.

The backpack 300 includes a secondary opening 330 for accepting deer feed. Accordingly, the backpack 300 opening 330 is openable and closable. In one embodiment, the backpack incorporates Velcro® by including soft-fuzzy loops 332 on a flap 331 and miniature plastic hooks 334 on a portion of a front panel 340 corresponding to the flap 331, and is operable in a well-known manner. Of course, many alternatives exist for enabling the opening to open and close, such as a zipper, or any other equivalent. In addition, it should be understood that although the opening is shown here in the top panel, the opening may also be located in any panel such that deer feed may be easily added to and maintained in the backpack 300.

An alternative dispenser 390 is illustrated in FIG. 4. The dispenser 390 includes a conduit 352 that couples a hose 350 with a feedbag punch 354. However, it should be understood that the hose 350 may also function as the conduit 352 in one embodiment. Additionally, the hose 350 includes a flexible hand-graspable member 352. Note here that the dispenser 390 is located in a bottom panel 360. The hand-graspable member 352 allows a user to dispense deer feed by merely not squeezing the hand-graspable member 352 while holding its mouth lower than the level of the deer feed in the backpack 300. Similarly, by squeezing the hand-graspable member 352, a user can control the flow-rate of the deer feed, or cut off the flow of deer feed altogether. Alternatively, the flow of deer feed may be halted by raising the mouth of the hose 350 to a level higher than the deer feed in the backpack 300, and thus it is advantageous to clip (via clip 395), wrap or otherwise attach the mouth of the hose to the frame 320 at a point near the top of the frame 320.

Here, the bottom panel 360 of the chamber is an inclined plane that descends to the dispenser 390, such that the deer feeder dispenser 390 is disposed along a bottom portion of the inclined planed bottom panel 360. The feedbag punch 354 extends from the conduit 352 and into the interior a sufficient length to puncture a feedbag and allow feed to flow to the conduit. The feedbag punch 354 in one embodiment comprises a circular/triangular puncture portion, analogous to an oilcan punch and pour tool. Of course, many alternative equivalents are readily apparent to those of ordinary skill in the art upon reading the invention, and all such equivalents known, foreseeable or unforeseeable are incorporated within the teachings of the invention.

Also shown in FIGS. 3 and 4 is a backpack frame 320 coupled to the back panel 342 in any manner known in the camping arts. Preferably, the backpack 300 includes a backpack belt 322 coupled to the frame 320. Shoulder straps (not shown) are also preferably coupled to the frame 320 in a manner known in the camping arts.

Of course, it should be understood that the order of the acts of the algorithms discussed herein may be accomplished in different order depending on the preferences of those skilled in the art, and such acts may be accomplished as software. Furthermore, though the invention has been described with respect to a specific preferred embodiment, many variations and modifications (including equivalents) will become apparent to those skilled in the art upon reading the present application. It is therefore the intention that the appended claims and their equivalents be interpreted as broadly as possible in view of the prior art to include all such variations and modifications.

I claim:

1. A backpack assembly adapted to be carried on the back of a person, comprising:
a pack having a front panel, a back panel, and a chamber defined between the front and back panels;
the chamber having an interior defined by interior portions of panels, the interior portions comprising
an interior portion of the front panel,
an interior portion of the back panel,
an interior portion of a top panel, an interior portion of a bottom panel, and
interior portions of opposing side panels;
a pair of shoulder straps secured to the pack such that with the straps positioned over the shoulders of a user the front panel is generally parallel to the back of the user; and
a deer feed dispenser disposed on a panel, the dispenser comprising a conduit, and a conduit closer.

2. The backpack of claim 1 wherein the conduit closer is a zipper with lanyard.

3. The backpack of claim 1 wherein the conduit is a hose coupled to the panel and having a hand-graspable member.

4. The backpack of claim 1 wherein the bottom panel of the chamber is an inclined plane, wherein the deer feeder dispenser is disposed along a bottom portion of the inclined plane.

5. The backpack of claim 1 wherein the deer feed dispenser comprises a feed bag punch extending from the conduit and into the interior a sufficient length to puncture a feed bag and allow feed to flow to the conduit.

6. The backpack of claim 1 further comprising a backpack frame coupled to the back panel.

7. The backpack of claim 6 further comprising a backpack belt coupled to the frame.

8. The backpack of claim 1 wherein the deer feed dispenser is coupled to a side panel.

9. The backpack of claim 1 further comprising deer feed maintained in the interior of the chamber.

10. The backpack of claim 1 further comprising an opening for accepting deer feed.

11. The backpack of claim 11 wherein the opening is closable via Velcro™.

12. The backpack of claim 11 wherein the opening is closable via a zipper.

13. The backpack of claim 11 wherein the opening is located in the top panel.

14. The backpack of claim 11 wherein the opening is located in a side panel.

15. The backpack of claim 1 wherein the dispenser is located in the bottom panel.

16. The backpack of claim 1 wherein the dispenser is located on a side panel.

17. The backpack of claim 1 further comprising a first horizontal reinforcement coupled to the back panel, and having a first end of the shoulder straps coupled thereto.

18. The backpack of claim 17 further comprising a second horizontal reinforcement coupled to the back panel, and having a second end of the shoulder straps coupled thereto.

19. The backpack of claim 1 wherein the panels are mesh.

20. The backpack of claim 1 wherein the panels comprise a camouflaged exterior.
